(19) United States
(12) Patent Application Publication
(10) Pub. No.: US 2006/0080320 A1
(43) Pub. Date: Apr. 13, 2006

(54) Method for storing and searching e-mail data by classification

(75) Inventors: San-Liang Chu, Hsinchu City (TW); Charlie H. Chang, Hsinchu City (TW); Ching-Yao Lin, Shanhua Town (TW)

Correspondence Address: BRUCE H. TROXELL, 5205 LEESBURG PIKE, SUITE 1404, FALLS CHURCH, VA, 22041, US

(73) Assignee: National Center for High-Performance Computing

(21) Appl. No.: 11/028,598

(22) Filed: Jan. 5, 2005

(30) Foreign Application Priority Data
Sep. 24, 2004 (TW) 93128957

(51) Int. Cl. G06F 17/30

(52) U.S. Cl. 707/10

(57) ABSTRACT

This invention describes a method for storing and searching sets of e-mail data by classification so as to effectively organize mass quantities of e-mail data and to improve the searching and reading efficiency of e-mail reading programs. This method produces an electronic book from such data as well as produces chapter directories of different categories accordingly so that the user can read the content of his e-mail as if he's reading a book. The method of this invention involves first retrieving the e-mail of a specified period from an e-mail server or an e-mail file and then classifying the e-mail into different categories according to the attributes or contents thereof so as to enable the categories to be converted into the chapter directories of the electronic book and mapped to the actual content of the e-mail.

### 1. FIELD OF THE INVENTION

The result of this invention is a method of storing and searching e-mail data by classification. In particular, this invention classifies and stores e-mail data by converting it into an electronic book form.

### 2. BACKGROUND OF THE INVENTION

E-mail has become an indispensable communication tool in today's modern business society. Corporate e-mail often includes personal correspondence, commercial documents, confidential memos, trading agreements, business transactions, digitized assets, and perhaps even evidence of patent filings. Unfortunately, not all of the e-mail is useful or necessary. An ever-increasing amount of daily e-mail includes spam. Most e-mail, with the exception of spam, contains vitally important information for the corporation and its employees. The amount of e-mail accumulated in the inbox, though, can become overwhelming, even to the point that modern e-mail management software such as Outlook Express and Lotus Notes cannot easily access a particular e-mail. Often, this e-mail simply gets buried somewhere within the inbox. Because of the large amount of email amassed in the inbox, the user must often spend a great deal of time searching for one particular email. It is extremely difficult and time consuming to locate email that hasn't been properly categorized. Current e-mail programs such as Outlook (Express) and Eudora provide only the most basic of e-mail categorization. They are only able to perform a search with respect to a single characteristic (e.g. sender, subject, keyword, etc.). Because of the limited search method employed by these e-mail programs, the number of search results obtained is often quite large and still require the user to do an additional visual search.

There is no easy way for the user to find a specific e-mail using conventional e-mail reading programs. It is for this reason that we propose a simple way to classify, organize, and store e-mail data and produce an electronic book from that data that can be rapidly and easily searched when a specific e-mail must be located. This e-mail electronic book can also be stored on portable devices such as PDAs and mobile phones, thus, enabling the user the ability to search information “on the go.”

### SUMMARY OF THE INVENTION

The primary feature of this invention is to provide a method for storing and searching e-mail data by classification. The method of classification used in this invention classifies a plurality of e-mail data received within a specific time period and with respect to attributes and characteristics such as the received date, sender, subject, keyword, etc. It then converts the e-mail data into an electronic book that has different chapter directories that correspond to the attributes and characteristics so as to facilitate an efficient e-mail searching process and make reading e-mail more convenient.

A second feature of this invention is to provide a method for storing and searching e-mail data by classification which enables the electronic book, containing classified e-mail data, to be stored in a storage medium that can be carried by the user, thus achieving inquiry convenience and portability.

The storing of the e-mail data by classification is achieved via the following steps:
(a). providing a server device and a storage medium wherein the server device contains e-mail data,
(b). retrieving the e-mail data of a predetermined time period from the server device and storing that e-mail data in the storage medium,
(c). classifying the e-mail data stored in the storage medium into at least one chapter directory of an electronic book according to at least one characteristic of the e-mail data, and
(d). mapping the chapter directory to the content of the e-mail.

### DESCRIPTIONS OF DRAWINGS

FIG. 1 is an illustrative view of the invention's e-mail architecture.

FIG. 2 is an illustrative view of the invention's method for storing e-mail data by classification.

FIG. 3 is an illustrative view of the invention's electronic book including classification directories.

FIG. 4 is an operating flowchart of the invention's electronic book.

### PREFERRED EMBODIMENT DESCRIPTION

In order to further understand the features and benefits of this invention, please review the following detailed descriptions:

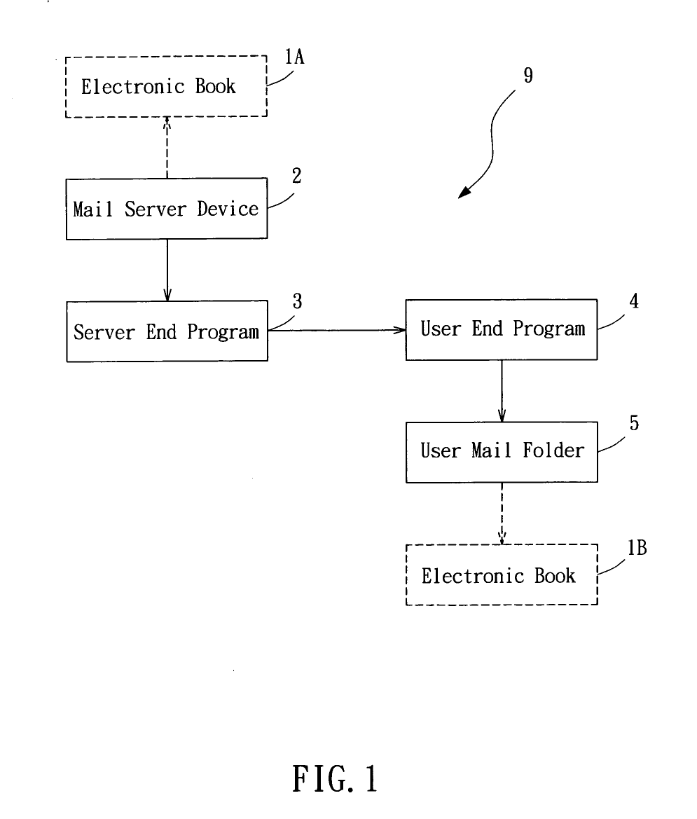

FIG. 1 is an illustrative view of the invention's e-mail architecture. In FIG. 1, the e-mail architecture 9 comprises a mail server device 2 such as a mail server, a server end program 3, a user end program 4, or a user mail folder 5. In general, an e-mail (not shown) is stored in the mail server device 2 and is remitted to the user's mail folder as soon as the user runs the user end program 4 to notice the server end program 3 through Post Office Protocol (POP) or Internet Message Access Protocol (IMAP) so as to retrieve the e-mail from the mail server device 2 and store it in the user mail folder 5. The e-mail data is stored in the mail server device 2 and the user mail folder 5. Accordingly, the method for storing e-mail data by classification is capable of retrieving the e-mail data of a specific time period from the e-mail data stored in the mail server device 2 and the user mail folder 5 and then converting the retrieved e-mail data respectively into an electronic book 1A and an electronic book 1B, each having classified directories. Such classification method will be described in a later section.

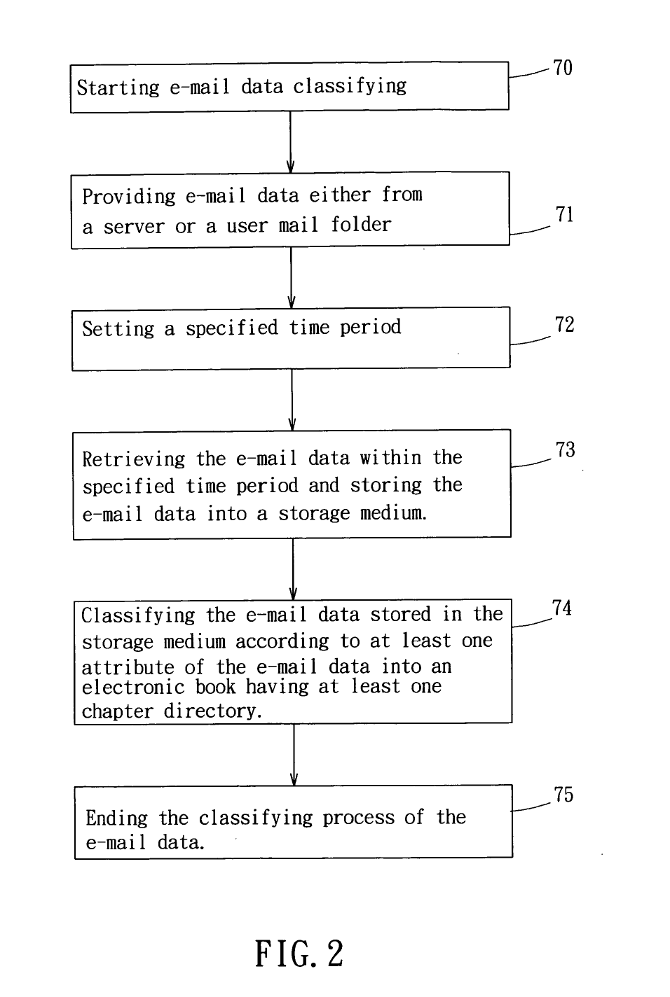

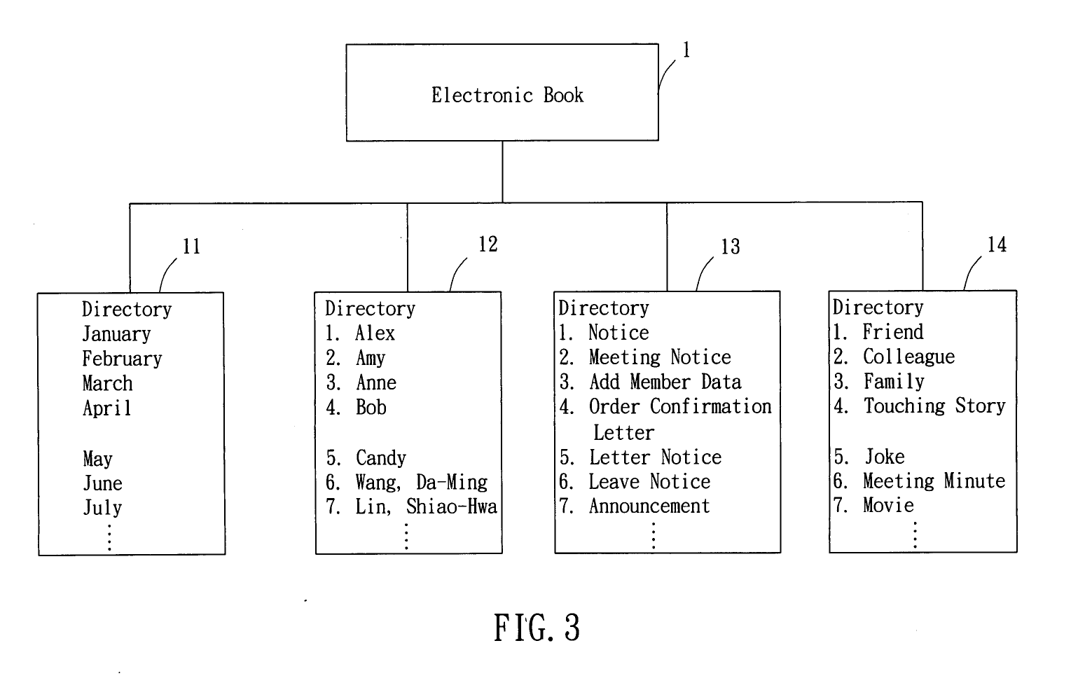

FIGS. 2 and 3 are illustrative views showing the method for storing e-mail data by classification and the electronic book having classified chapter directories. The process starts at step 70 where a classification operation is activated and then the flow proceeds to step 71. At step 71, the e-mail data is provided from a company's e-mail server or an individual's user mail folder and then the flow proceeds to step 72. At step 72, a time period, for example, January 2003 to December 2003, is set and then the flow goes to step 73. At step 73, the e-mail data within the specified time period is retrieved and stored into a storage medium such as a hard disk drive or flash memory and then the flow proceeds to step 74. At step 74, the e-mail data stored in the storage medium is classified with respect to at least one attribute or characteristic of the e-mail data into an electronic book having at least one chapter directory wherein the attribute or characteristic can be the received date, sender, subject, classified content, or keyword of the e-mail data. The attribute or characteristic could be any piece of user-defined information. The flow then goes to step 75. At step 75, the classification operation ends.

As seen in FIG. 3, the electronic book 1 comprises a first directory 11, a second directory 12, a third directory 13, and a fourth directory 14; wherein the first directory 11 is formed according to the received date of an e-mail; the second directory 12 is formed according to the sender of an e-mail; the third directory 13 is formed according to the subject of an e-mail; and the fourth directory 14 is formed according to the content and category of an e-mail. Hence, when a user intends to search for specific content, for example, a meeting notice, the user needs only to enter the third directory 13 of the electronic book 1 to select the category of meeting notice and read all of the meeting notices so as to find the specific one he's looking for. In addition, if the user wants to have all e-mail data received during March 2003, the user simply turns to the first directory 11 to select March 2003 in order to obtain the required e-mail data. Furthermore, this method enables the user to perform multiple searches with respect to different categories. As an example the user enters into the third directory 13 to select the meeting notice and then enters into the first directory 11 to select March 2003. This produces results such that the e-mail data regarding meeting notice within March 2003 will be obtained.

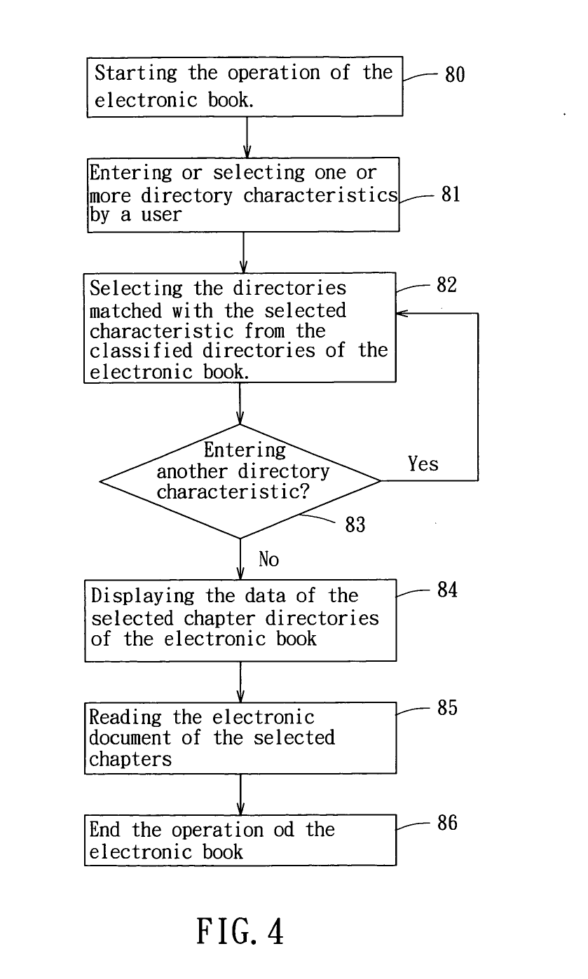

FIG. 4 is an illustrative view showing an operating flowchart of the electronic book. The operating procedure of an electronic book starts at step 80 and then proceeds to step 81. At step 81, one or more directory characteristics, for example, the received data, sender, subject, classified content, or keyword are input by the user. The flow then proceeds to step 82. At step 82, the directories matched with the inputted characteristic are selected from the classified directories of the electronic book, and then the flow proceeds to step 83. At the step 83, an evaluation is made to determine whether or not the user intends to input another directory characteristic. If yes, the flow goes back to step 82, otherwise, the flow proceeds to step 84. At step 84, the electronic book's selected chapter directory data is displayed to help facilitate the user's reading of the email. The flow then proceeds to step 85. At step 85, the user reads the selected chapter's document and the flow then proceeds to step 86. At step 86, the operating procedure of the electronic book ends.

Since the classified electronic book is stored in a storage medium, the user can carry the storage medium with the stored electronic book and display the content of the electronic book by an appropriate operation of a platform device. This greatly improves the application's convenience factor and allows the user to search data at their leisure.

While the preferred embodiment of the invention has been set forth for the purpose of disclosure, modifications of the invention's disclosed embodiment as well as other embodiments thereof may be performed by those skilled in the art. Accordingly, the appended claims are intended to cover all embodiments that do not depart from the spirit and scope of the invention.

What is claimed is:

1. A method for storing e-mail data by classification, comprising: providing a server device and a storage medium wherein the server device contains e-mail data; retrieving the e-mail data of a predetermined time period from the server device and storing the retrieved e-mail data in the storage medium; classifying the e-mail data stored in the storage medium into at least one chapter directory of an electronic book according to at least one characteristic category of the e-mail data; and mapping the chapter directory to the content of the e-mail.

2. The method of claim 1, wherein the e-mail data is stored in a mail server.

3. The method of claim 1, wherein the e-mail data is stored in a user mail folder.

4. The method of claim 1, wherein the e-mail data is accessible to the user.

5. The method of claim 1, wherein the characteristic is the received date of each e-mail data.

6. The method of claim 1, wherein the characteristic is the sender of each e-mail data.

7. The method f of claim 1, wherein the characteristic is the subject of each e-mail data.

8. The method of claim 1, wherein the characteristic is the keyword of each e-mail data.

9. The method of claim 1, wherein the storage medium is a hard disk drive.

10. The method of claim 1, wherein the storage medium is a flash memory.

11. The method of claim 1, wherein the electronic book is capable of being executed by an electronic device.

12. The method of. claim 11, wherein the electronic device is a personal computer (PC).

13. The method of claim 12, wherein the electronic device is a portable device.

14. The method of claim 13, wherein the portable device is a personal digital assistant (PDA).
